(19) United States
(12) Patent Application Publication
(10) Pub. No.: US 2014/0289609 A1
(43) Pub. Date: Sep. 25, 2014

(54) Method For Implementing Off-Line Application and Apparatus Therefor

(71) Applicant: Tencent Technology (Shenzhen) Company Limited, Shenzhen (CN)

(72) Inventor: Haijian Long, Shenzhen (CN)

(73) Assignee: Tencent Technology (Shenzhen) Company Limited, Shenzhen (CN)

(21) Appl. No.: 14/288,625

(22) Filed: May 28, 2014

Related U.S. Application Data
(63) Continuation of application No. PCT/CN2013/088459, filed on Dec. 3, 2013.

(30) Foreign Application Priority Data
Mar. 20, 2013 (CN) 201310090189.3

(51) Int. Cl. G06F 17/22

(52) U.S. Cl. CPC G06F 17/2247
USPC 715/234

(57) ABSTRACT

Provided is a method for implementing off-line application and an apparatus therefor. The method includes: sending, when a browser is in an off-line status, an Ajax request to a browser buffer according to an HTML5 application access request; obtaining data required for running the HTML5 application, returned from the browser buffer in response to the Ajax request; running the HTML5 application according to the data required for running the HTML5 application. In the present disclosure, the HTML5 off-line application is combined with the browser buffer, so the buffering space of the offline application is infinite, more application data may be buffered, thus providing a more smooth off-line service.

### REFERENCE TO PRIOR APPLICATIONS

This application is a continuation of International Patent Application No. PCT/CN2013/088459, file on Dec. 3, 2013, which claims priority to Chinese Patent Application No. 201310090189.3, with a title of “METHOD FOR IMPLEMENTING OFF-LINE APPLICATION AND APPARATUS THEREFOR”, filed on Mar. 20, 2013 in State Intellectual Property Office of China, the disclosures of which are herein incorporated by reference.

### FIELD OF INVENTION

The present disclosure relates to a field of computer technology, and particularly, to a method for implementing off-line application and apparatus therefor.

### BACKGROUND

With a growing popularity of mobile terminals and continuous development of HTML5 technology, it is becoming more convenient to browse a network through mobile terminals and therefore, usage of terminal devices has been increasing. However, current mobile networks themselves can not cater users' demands at all times, especially in a movement scenario. Specifically, when a network signal is fairly weak or the network is disconnected, the network would fail to deliver complete services to a user of a terminal device, or the network would even be unavailable, in this case, the user's experience is cut off and not smooth.

A solution in the prior art to address the above-mentioned situation of weak network signal or network disconnection is to pre-buffer the data of an application to be accessed, and invoke buffered data to maintain a normal usage of the application when the network signal is weak or the network is disconnected. However, the butler capacity in the solution of the prior art is limited and cannot buffer more application data and thus is unable to deliver continuous off-line services.

### SUMMARY

An embodiment of the present disclosure provides a method for implementing off-line application, the method includes:

sending, when a browser is in an off-line status, an Ajax request to a browser buffer according to an HTML5 application access request;

obtaining data required for running the HTML5 application, returned from the browser buffer in response to the Ajax request;

running the HTML5 application according to the data required for running the HTML5 application.

Another embodiment of the present disclosure provides an apparatus for implementing off-line application, the apparatus includes:

a request sending unit, configured to when a browser is in an off-line status, send an Ajax request to a browser buffer according, to an HTML5 application access request;

an obtaining unit, configured to, obtain data required for running the HTML5 application, returned from the browser buffer in response to the Ajax request;

a running unit, configured to run the HTML5 application according to the data required for running the HTML5 application.

As can be seen from the above solutions, according to the present disclosure, the HTML5 off-line application is combined with the Browser buffer, so the buffering space of the off-line application is infinite, more application data may be buffered, thus providing a more smooth off-line service.

### BRIEF DESCRIPTION OF THE DRAWINGS

In order to explain the technical solutions of the embodiments of the present disclosure more clearly, the drawings needed in the description of the embodiments will be briefly introduced. It is apparent that the drawings described below are only some embodiments of the present disclosure, and other drawings may be obtained from these drawings without any inventive effort for an ordinary person skilled in the art.

FIG. 1 is a flow chart of a method for implementing off-line application according to one embodiment of the present disclosure;

FIG. 2 is a schematic diagram of a process for implementing off-line application according to the one embodiment of the present disclosure;

FIG. 3 is a flow chart of an implementation of browser buffer updating according to the one embodiment of the present disclosure;

FIG. 4 is a structural diagram of an apparatus for implementing off-line application according to another embodiment of the present disclosure;

FIG. 5 is a structural diagram of a force update part in the apparatus for implementing off-line application according to the another embodiment of the present disclosure.

### DETAILED DESCRIPTION

Objects, technical solutions and advantages of the present disclosure will become more clear from the detailed description given hereinafter with reference to the drawings and embodiments. It should be understood that the specific embodiments described herein only serve the purpose of illustrating the present disclosure, and shall not be used to limit the present disclosure.

“Off-line application” mentioned in the present disclosure refers to a mechanism of opening a webpage in the case that a network is disconnected, provided by a browser; “Browser buffer” refers to a buffering mechanism that the browser uses local contents in a period of validity. These concepts are well known in the art, and will not be described specifically.

Now implementations of the present disclosure will be described in details in combination with specific embodiments:

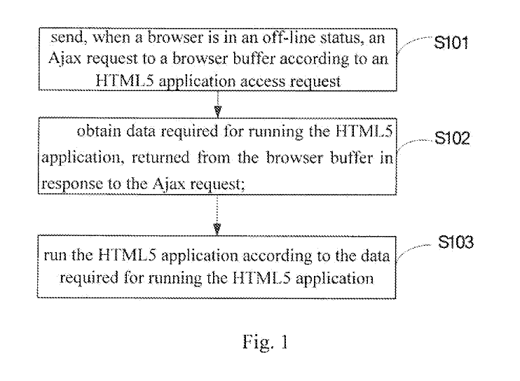

FIG. 1 is a flow chart of a method for implementing off-line application according to one embodiment of the present disclosure, which is described in details as follows.

In S101, when a browser is in an off-line status, an Ajax request is sent to a browser buffer according to an HTML5 application access request;

In S102, data required for running the HTML5 application, returned from the browser butler in response to the Ajax request, is obtained:

In this embodiment, data corresponding to the HTML5 application stored by the local Browser butler may be obtained as follows. When the browser is in an on-line status, data required for running the HTML5 application are pre-read from a WEB server by a Javascript program (Js program), and then stored by the Browser buffer. That is to say, according to an HTML5 application being used by the user, the Js program determines the data required for running the HTML5 application, then the Js program pre-reads the data required for running the HTML5 application from a WEB server according to a result of the determination, and stores the data by the Browser buffer. The amount of the data the Js program pre-read from the WEB server may certainly preset by a user. For example, when the user is on-line reading a novel, he or she may preset the data need to be pre-read by the Js program is the contents of 2 chapters.

In this embodiment, the local browser buffer returns the data required for running the HTML5 application to the browser according to the Ajax request. As the browser buffer is located on a disk, so there is more buffering space.

In S103, the browser runs the HTML5 application according to the data required for running the HTML5 application.

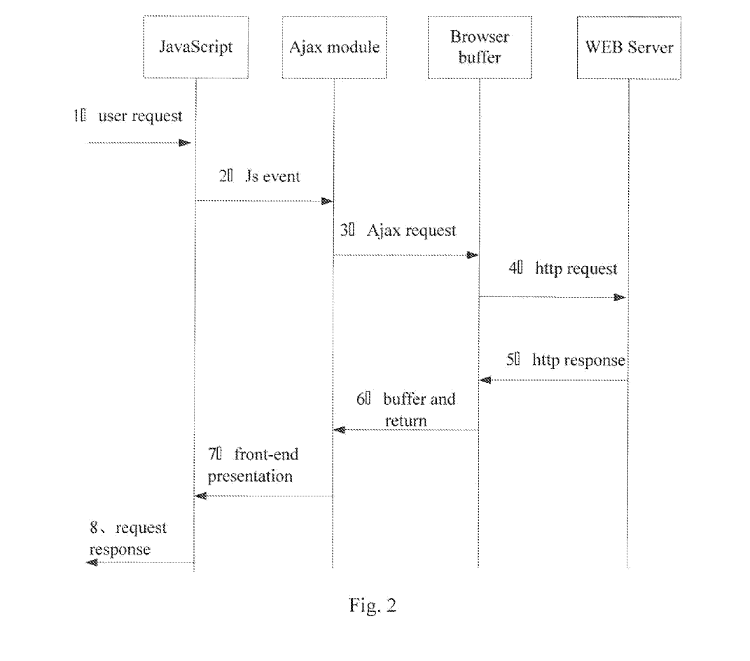

For ease of understanding, a specific implementation example will be given to explain the method for implementing off-line application in the present embodiment, but the present disclosure is not limited thereto. It is assumed that the current user is on-line reading a novel, then the browser obtains the content of reading according to a process of 1->2->3->4->5->6->7->8->, as shown in FIG. 2. Specifically, the browser receives the user's reading request, and determines by a is event that the content to be pre-read is the first N chapters, then an Ajax request is sent to the browser buffer from the browser, the browser buffer obtains the content of the first N chapters from a WEB server by an http request and stores the obtained content of the first N chapters in the browser buffer, and then present content to the user to read by a response message. Thereafter, if the network signal is weak or the network is disconnected, the browser may obtain the pre-read data front the browser buffer, and a process for obtaining the data is 1->2->3->4->5->6->7->8, as shown in FIG. 2.

In this embodiment, the HTML5 off-line application is combined with the Browser buffer, so the buffering space of the off-line application is infinite, more application data may be buffered, thus providing a more smooth off-line service.

According to an embodiment of the present disclosure, in order to make the data buffered by the browser buffer provide timely and accurate information to the user, a verification may be performed on the buffered data to update the buffered data timely. A process of the verification may be as follows.

In the case that the browser is in an on-line status, an MD5 verification may be performed on the data of the HTML5 application stored by the browser buffer and the data of the HTML5 application stored on a WEB server, in response to a predetermined condition, such as an access request to the data of the HTML 5 application is received.

If an MD5 value of the data of the HTML5 application stored by the Browser buffer is the same as the data of the HTML5 application stored on the WEB server, it is indicated that the data of the HTML5 application stored by the Browser buffer are the latest data, and thus there is no need to update the data of the HTML5 application stored by the browser buffer.

If the MD5 value of the data of the HTML5 application stored by the Browser buffer is different from the data of the HTML5 application stored on the WEB server, it is indicated that the data of the HTML5 application stored in the Browser buffer are not the lately updated data, and then the data of the HTML5 application stored by the Browser buffer is updated.

In this embodiment, it may be known in a timely manner whether the data of the HTML5 application stored by the browser buffer are lately updated data by performing a MD5 verification, so as to prevent incorrect application data from being buffered.

As another embodiment of the present disclosure, according to the attribute of Ajax request mechanism, when the browser is in an on-line status, and an access is made to a same application again, the browser buffer received the access request will not sent the access request to a WEB server, but returns the data buffered therein to the browser directly. Therefore, the browser would obtain data previously buffered in the browser buffer. If the data on the WEB server have been updated, the browser may obtain incorrect data, because the data in the browser buffer have not been updated. Therefore, the data in the browser buffer must be updated in a timely manner, and the following approach may be adopted to update data in the browser buffer mandatorily. FIG. 3 shows a flow chart of an implementation of browser buffer updating according to the one embodiment of the present invention.

In S301, a URL address corresponding to the HTML5 application is modified in response to an update request to data corresponding to the HTML5 application.

In this embodiment, the update request may be a request to refresh the HTML5 application.

In S302, a modified URL address is sent.

In this embodiment, after the URL address corresponding to the application has been mandatorily modified, data corresponding to the modified URL address can not be obtained from a browser butler, and thus the modified URL address will be forwarded to a WEB server. It should be noted that, said modification does not really change an access path of the URL address, and an only purpose of the modification is to ensure the browser buffer would forward the modified URL address to the WEB server because of failing to provide data corresponding to the modified URL address. After performing a resolution on the modified URL address, the WEB server knows the real address to be accessed is still the URL address corresponding to the HTML 5 application, and thus the data corresponding to the HTML5 application can be obtained from the WEB server.

Optionally, S301 may be implemented by adopting the following approach: adding a random number to parameters of the URL address to which the HTML5 application corresponds, according to the refreshing request. The WEB server knows URL address formats in advance, and thus it will remove the random number when performing an address resolution, thereby obtaining the real URL address corresponding to the HTML 5 application. The URL address may be modified in an easy and convenient manner by adding a random number in the parameters of the URL address.

In S303, the data corresponding to the HTML5 application returned from a WEB server according to the modified URL address is received.

In S304, the data corresponding to the HTML5 application stored in the browser buffer is updated according to the data corresponding to the HTML5 application returned from the WEB server.

Therefore, the HTML5 application may run according to the updated data corresponding to the HTML5 application, stored in the browser buffer.

In this embodiment, when the browser is in an on-line status, on reception of a user's refreshing request, the data in the browser buffer may be updated in a timely manner by modifying the URL address corresponding to the HTML5 application, so a situation where the data on server have been updated while the data stored in the browser buffer is not updated may be avoided, and further a situation where the data not being updated are obtained from the browser buffer in an on-line or off-line access may be avoided.

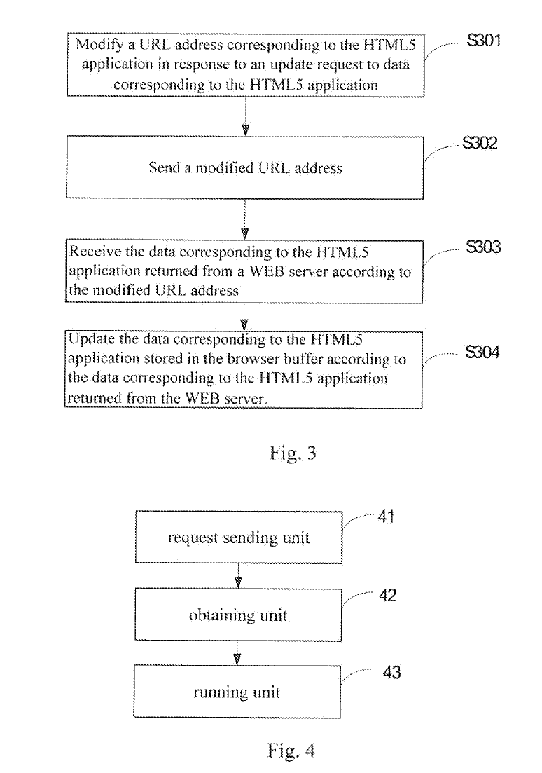

FIG. 4 shows a structural diagram of an apparatus for implementing off-line application according to another embodiment of the present disclosure. For ease of illustration, only the parts related to the embodiment of the present disclosure are shown, and the apparatus may be a software unit, a hardware unit or a unit combining software and hardware built in a mobile terminal.

The apparatus includes: a request sending unit 41, configured to when a browser is in an off-line status, send an Ajax request to a browser buffer according to an HTML5 application access request; an obtaining unit 42, configured to, obtain data required for running the HTML5 application, returned from the browser buffer in response to the Ajax request; a running unit 43, configured to run the HTML5 application according to the data required for running the HTML5 application.

Alternatively, the apparatus further includes a pre-reading unit 44, configured to, when the browser is in an on-line status, pre-read data required for running the HTML5 application from a WEB server by a Js program, and store the data by the browser buffer.

Alternatively, the apparatus further includes: a verification unit 46, configured to, when the browser is in an on-line status, perform an MD5 verification on data of the HTML5 application stored in the browser buffer and data of the HTML5 application stored on a WEB server; and a first updating unit 47, configured to update the data of the HTML5 application stored in the browser buffer, if an MD5 value of the data of the HTML5 application stored in the browser buffer is different from the data of the HTML5 application stored on the WEB server.

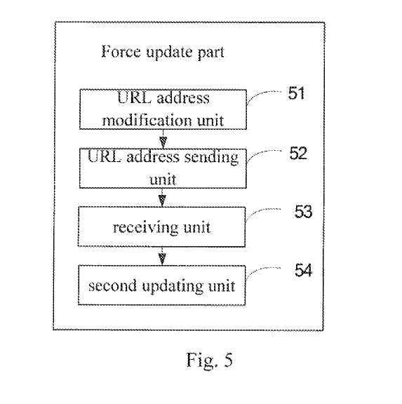

Alternatively, as shown in FIG. 5, the apparatus for implementing off-line application according to the another embodiment of the present disclosure may further includes a force update part. The force update part includes: a URL address modification unit 51, a URL address sending unit 52, a receiving unit 53 and a second updating unit 54.

The URL address modification unit 51 is configured to, when the browser is in an on-line status, modify a URL address corresponding to the HTML5 application in response to an update request to data corresponding to the HTML5 application.

The URL address sending unit 52 is configured to send a modified URL address.

The receiving unit 53 is configured to receive the data corresponding to the HTML5 application returned from a WEB server according to the modified URL address.

The second updating unit 54 is configured to update the data corresponding to the HTML5 application stored in the browser buffer, according to the data corresponding to the HTML5 application returned from the WEB server.

Alternatively, the URL address modification unit 51 is specifically configured to add a random number to parameters of the URL address to which the HTML5 application corresponds according, to the refreshing request.

The apparatus for implementing off-line application according to the embodiment of the present disclosure may be applied to the corresponding method embodiment described above, the details may be referred to the descriptions for the one embodiment and will be omitted herein.

It should be noted that, in the embodiment described above, the various units included therein are only divided by functional logics and are not limited to such a division as long as corresponding functions may be implemented. Furthermore, the specific names of various function units only serve the purpose of distinguishing one from the other, and should not be used to limit the scope of the present disclosure.

Further, an ordinary person skilled in the art should understand that all or part of the processes in the above various embodiments may be achieved by programs instructing related hardware, the program may be stored in a computer readable storage medium such as ROM/RAM, disk or optical disk. Specifically, the computer-readable storage medium may have instructions stored thereon, the instructions, when executed by one or more processors, cause the processors to perform operations comprising: sending, when a browser is in an off-line status, an Ajax request to a browser buffer according to an HTML5 application access request; obtaining data required for running the HTML5 application, returned from the browser buffer in response to the Ajax request; running the HTML5 application according to the data required for running the HTML5 application.

The above descriptions are only embodiments of the present disclosure, and not for limiting the present disclosure. Any variation, equivalent substitution or modification as falls in the spirit and principle of the present disclosure are intended to be included within the scope of the present disclosure.

What is claimed is:

1. A method for implementing off-line application, comprising:
sending, when a browser is in an off-line status, an Ajax request to a browser buffer according to an HTML5 application access request;
obtaining data required for running the HTML5 application, returned from the browser buffer in response to the Ajax request;
running the HTML5 application according to the data required for running the HTML5 application.

2. The method according to claim 1, further comprising:
when the browser is in an on-line status, pre-reading data required for running the HTML5 application from a WEB server by a JavaScript program, and storing the data by the browser buffer.

3. The method according to claim 1, further comprising:
when the browser is in an on-line status, performing an MD5 verification on data of the HTML5 application stored in the browser buffer and data of the HTML5 application stored on a WEB server; and updating the data of the HTML5 application stored in the browser buffer, if an MD5 value of the data of the HTML5 application stored in the browser buffer is different from the data of the HTML5 application stored on the WEB server.

4. The method according to claim 1, further comprising:
modifying a URL address corresponding to the HTML5 application in response to an update request to data corresponding to the HTML5 application, when the browser is in an on-line status;
sending a modified URL address;
receiving the data corresponding to the HTML5 application returned from a WEB server according to the modified URL address;
updating the data corresponding to the HTML5 application stored in the browser buffer, according to the data corresponding to the HTML5 application returned from the WEB server.

5. The method according to claim 2, further comprising;
modifying a URL address corresponding to the HTML5 application in response to an update request to data corresponding to the HTML5 application, when the browser is in an on-line status;
sending a modified URL address;
receiving the data corresponding to the HTML5 application returned from a WEB server according to the modified URL address;
updating the data corresponding to the HTML5 application stored in the browser buffer, according to the data corresponding to the HTML5 application returned from the WEB server.

6. The method according to claim 3, further comprising:
modifying a URL address corresponding to the HTML5 application in response to an update request to data corresponding to the HTML5 application, when the browser is in an on-line status;
sending a modified URL address;
receiving the data corresponding to the HTML5 application returned from a WEB server according to the modified URL address;
updating the data corresponding to the HTML5 application stored in the browser buffer, according to the data corresponding to the HTML5 application returned from the WEB server.

7. The method according to claim 4, wherein, modifying a URL address corresponding to the HTML5 application comprises:
adding a random number to parameters of the URL address corresponding to the HTML5 application.

8. An apparatus for implementing off-line application, comprising:
a request sending unit, configured to, when a browser is in an off-line status, send an Ajax request to a browser buffer according to an HTML5 application access request;
an obtaining unit, configured to, obtain data required for running the HTML5 application, returned from the browser buffer in response to the Ajax request;
a running unit configured to run the HTML5 application according to the data required for running the HTML5 application.

9. The apparatus according to claim 8, further comprising:
a pre-reading unit, configured to, when the browser is in an on-line status, pre-read data required for running the HTML5 application from a WEB server by a JavaScript program, and store the data by the browser buffer.

10. The apparatus according to claim 9, further comprising:
a verification unit, configured to, when the browser is in an on-line status, perform an MD5 verification on data of the HTML5 application stored in the browser buffer and data of the HTML5 application stored on a WEB server;
a first updating unit, configured to update the data of the HTML5 application stored in the browser buffer, if an MD5 value of the data of the HTML5 application stored in the browser buffer is different from the data of the HTML5 application stored on the WEB server.

11. The apparatus according to claim 8, further comprising:
a URL address modification unit, configured to, when the browser is in an on-line status, modify a URL address corresponding to the HTML5 application in response to an update request to data corresponding to the HTML5 application;
a URL address sending unit, configured to send a modified URL address;
a receiving unit, configured to receive the data corresponding to the HTML5 application returned from a WEB server according to the modified URL address;
a second updating unit, configured to update the data corresponding to the HTML5 application stored in the browser buffer, according to the data corresponding to the HTML5 application returned from the WEB server.

12. The apparatus according to claim 9, further comprising:
a URL address modification unit, configured to, when the browser is in an on-line status, modify a URL address corresponding to the HTML5application in response to an update request to data corresponding to the HTML5 application;
a URL address sending unit, configured to send a modified URL address;
a receiving unit, configured to receive the data corresponding to the HTML5 application returned from a WEB server according to the modified URL address;
a second updating unit, configured to update the data corresponding to the HTML5 application stored in the browser buffer, according to the data corresponding to the HTML5 application returned from the WEB server.

13. The apparatus according to claim 10, further comprising:
a URI, address modification unit, configured to, when the browser is in an on-line status, modify a URL address corresponding to the HTML5 application in response to an update request to data corresponding to the HTML5 application;
a URL address sending unit, configured to send a modified URL address;
a receiving unit, configured to receive the data corresponding to the HTML5 application returned from a WEB server according to the modified URL address;
a second updating unit, configured to update the data corresponding to the HTML5 application stored in the browser buffer, according to the data corresponding to the HTML5 application returned horn the WEB server.

14. The apparatus according to claim 11, wherein, the URL address modification unit is configured to add a random number to parameters of the URL address corresponding to the HTML5 application.

15. A non-transitory computer-readable storage medium having instructions stored thereon, the instructions, when executed by one or more processors, cause the processors to perform operations comprising:
sending, when a browser is in an off-line status, an Ajax request to a browser butler according to an HTML5 application access request;
obtaining data required for running the HTML5 application returned from the brows r butler in response to the Ajax request;
running the HTML5 application according to the data required for running the HTML5 application.
